(19) United States
(12) Patent Application Publication
(10) Pub. No.: US 2010/0188847 A1
(43) Pub. Date: Jul. 29, 2010

(54) Lamp holder

(76) Inventor: Chia-Yi Chen, Pingtung County (TW)

Correspondence Address: CHARLES E. BAXLEY, ESQUIRE, 90 JOHN STREET, SUITE 309, NEW YORK, NY, 10038, US

(21) Appl. No.: 12/321,875

(22) Filed: Jan. 27, 2009

(51) Int. Cl. F21V 7/22; G02B 5/12

(52) U.S. Cl. 362/235; 359/850

(57) ABSTRACT

A lamp holder is made by extrusion of aluminum. The lamp holder includes at least one recess for receiving an illuminator. The recess is defined by a mounting face, a first reflective face and a second reflective face. The mounting face is at 18 to 25 degrees from a horizontal plane. The first reflective face is at 120 to 130 degrees from a lower edge of the mounting face. The second reflective face is at 110 to 120 degrees from an upper edge of the mounting face.

### FIELD OF INVENTION

The present invention relates to a lamp holder for holding at least one light-emitting diode (“LED”) to provide even illumination within a large range and, more particularly, to an inexpensive illumination module using at least one such lamp holder.

### BACKGROUND OF INVENTION

As technology develops, demand of energy increases. However, we are running out of fossil fuel such as gasoline and coal. Moreover, the consumption of the fossil fuel is connected to serious environmental problems. For example, the combustion of the fossil fuel generates carbon dioxide that causes the greenhouse effect that in turn entails global warming. Hence, it is important to search for and use environmentally friendly energy such as wind power and solar energy. It is equally important to reduce the demand of energy by using low-consumption, durable devices. For example, LEDs are used instead of light bulbs and incandescent light tubes for being low in consumption of energy, long in life, and excellent and reliable in performance.

An LED is inadequate for illumination for its small size. Generally, a plurality of LEDs is used together to provide adequate illumination. A lamp holder has to be designed carefully for an array of LEDs to provide even illumination within a large range.

Therefore, the present invention is intended to obviate or at least alleviate the problems encountered in prior art.

### SUMMARY OF INVENTION

It is the primary objective of the present invention to provide a lamp holder for holding at least one LED to provide even illumination within a large range.

To achieve the foregoing objective, the lamp holder is made by extrusion of aluminum and includes at least one recess for receiving an illuminator. The recess is defined by a mounting face, a first reflective face and a second reflective face. The mounting face is at 18 to 25 degrees from a horizontal plane. The first reflective face is at 120 to 130 degrees from a lower edge of the mounting face. The second reflective face is at 110 to 120 degrees from an upper edge of the mounting face. Other objectives, advantages and features of the present invention will become apparent from the following description referring to the attached drawings.

### BRIEF DESCRIPTION OF DRAWINGS

The present invention will be described via detailed illustration of embodiments referring to the drawings.

FIG. 1 is a front view of a lamp holder according to a first embodiment of the present invention.

FIG. 2 is a front view of two lamp holders as shown in FIG. 1, arranged side by side.

FIG. 3 is a partial, perspective view of a light tube using two lamp holders.

FIG. 4 is a partial, perspective view of a streetlamp using two lamp holders.

FIG. 5 is a front view of a lamp holder according to a second embodiment of the present invention.

FIG. 6 is a front view of a lamp holder according to a third embodiment of the present invention.

### DETAILED DESCRIPTION OF EMBODIMENTS

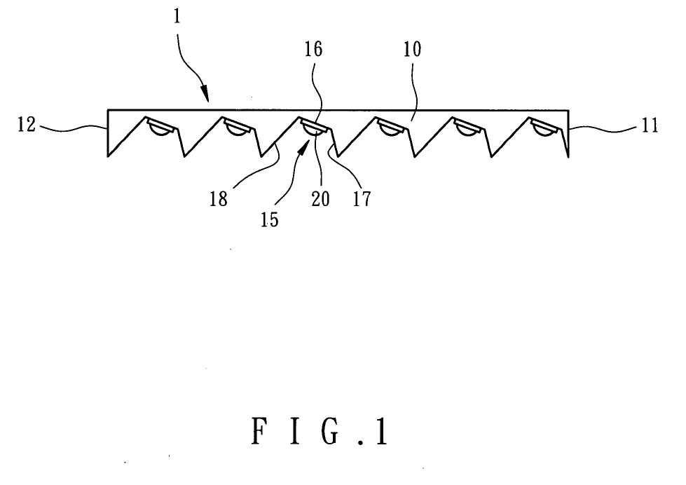

Referring to FIG. 1, there is shown a lamp holder 10 according to a first embodiment of the present invention. The lamp holder 10 includes a side 11 and a side 12 opposite to the side 11. The lamp holder 10 includes at least one recess 15. The recess 15 is defined by a mounting face 16 and two reflective faces 17 and 18 extended from the mounting face 16. The mounting face 16 is 18 to 25 degrees and, preferably, 20 degrees from a horizontal plane. The mounting face 16 gets lower as it extends towards the side 11. An LED 20 is attached to the mounting face 16. The reflective face 17 is closer to the side 11 than the reflective face 18 is. The reflective face 17 is 120 to 130 degrees and, preferably, 124 degrees from the mounting face 16. The reflective face 18 is 110 to 120 degrees and, preferably, 114 degrees from the mounting face 16.

In operation, an illuminator 20 such as an LED is attached to the mounting face 16. The angles of the mounting face 16 and reflective faces 17 and 18 are carefully selected so that the lamp holder 10 spreads light emitted from the LED 20 within a large range with an adequate luminance. Otherwise, the lamp holder 10 might spread the light within an inadequate range with an excessive luminance or within an excessive range with an adequate luminance.

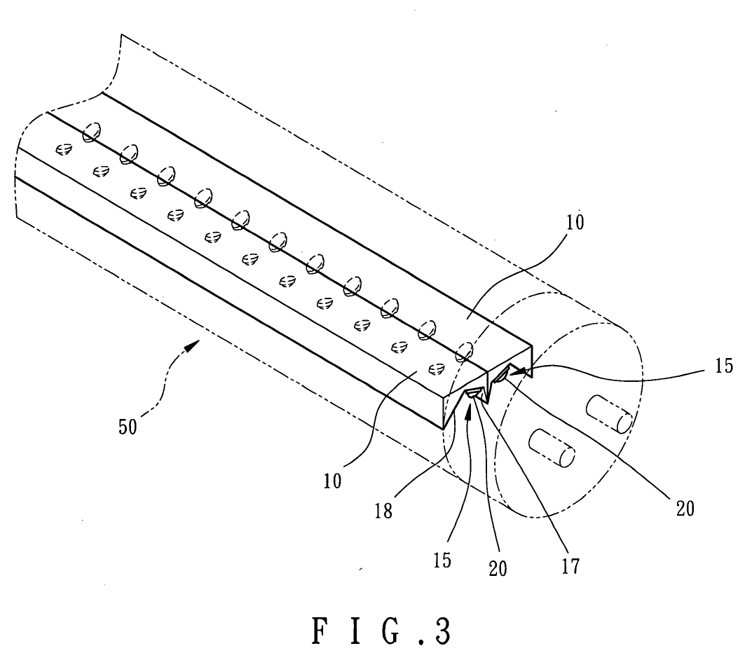

The lamp holder 10 preferably includes a plurality of recesses 15. The recesses 15 may be arranged in a longitudinal manner as shown in FIG. 1 or in a transverse manner as shown in FIG. 3. In the longitudinal manner, the reflective faces 17 are parallel to one another, and so are the reflective faces 18. In the transverse manner, the reflective faces 17 are in a common plane, and so are the reflective faces 18.

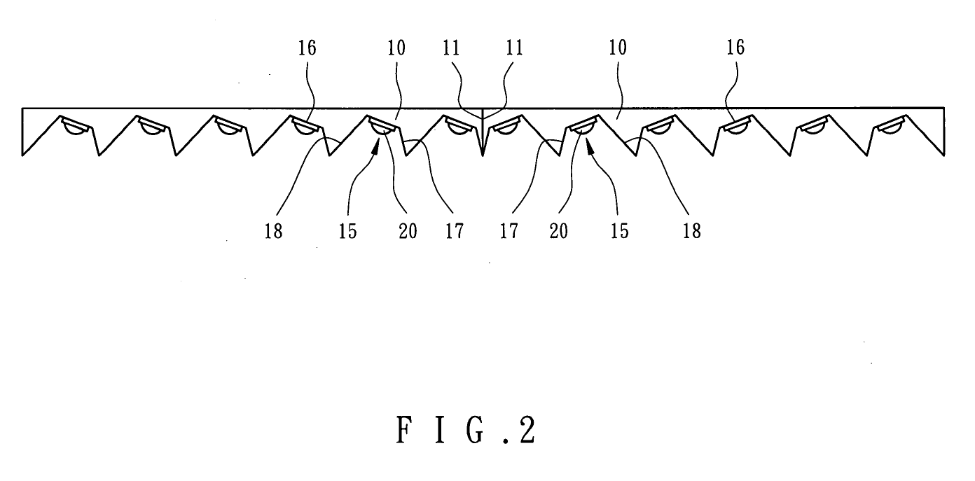

Referring to FIG. 2, two lamp holders 10 are arranged side by side to form an illumination apparatus 1. In detail, the side 11 of one of the lamp holders 10 is connected to the side 11 of the other lamp holder 10. Thus, the illumination apparatus 1 emits and spreads light evenly within a large range, in an outward sense of direction.

An additional lamp holder 10 can be assembled with the previous lamp holders shown in FIG. 2. In detail, the side 11 of the additional lamp holder 10 is attached to the side 12 of one of the previous lamp holders 10 so that the holders 10 spread light downwards and outwards.

Referring to FIG. 3, two lamp holders 10 are used in a light tube 50. The recess 15 defined in each of the lamp holders 10 is a groove. A plurality of LEDs 20 is attached to the mounting face 16 of the groove 15 of each of the lamp holders 10. In each of the lamp holders 10, the groove 15 may be replaced with separate recesses each for receiving an LED 20.

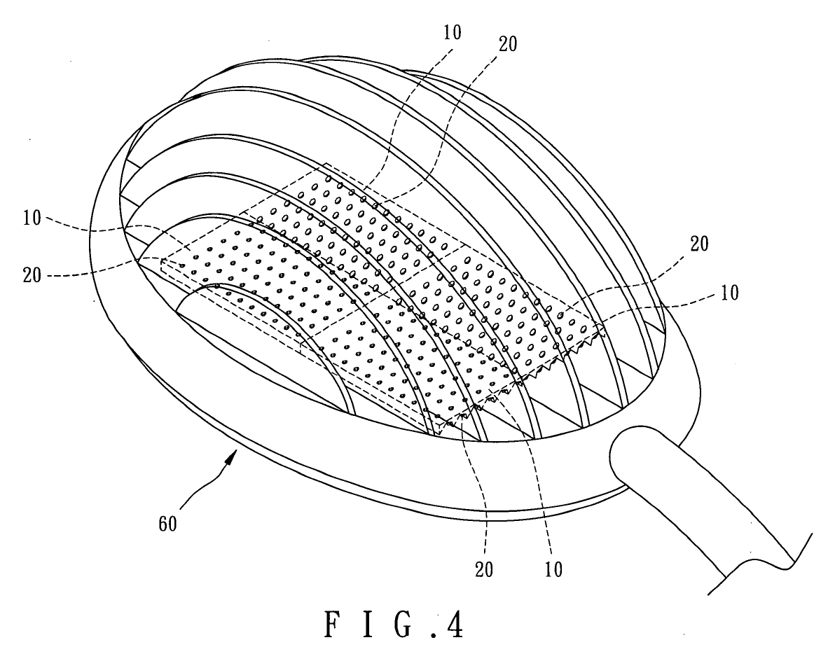

Referring to FIG. 4, four lamp holders 10 are used in a streetlamp 60. The recesses 15 defined in each of the lamp holders 10 are in the form of grooves parallel to one another. A plurality of LEDs 20 is attached to the mounting face 16 of each of the grooves 15 of each of the lamp holders 10.

The lamp holders 10 are made by extrusion of aluminum. In detail, a flat blank with grooves defined in a side is made by extrusion of aluminum. The flat blank can be cut in a first manner to make lamp holders 10 as shown in FIG. 1. The flat blank can be cut in a second manner to make lamp holders 10 as shown in FIG. 3. The flat blank can be cut in a third manner to make lamp holders 10 as shown in FIG. 4. Thus, each of the lamp holders 10 is made with a proper width and length before the lamp holders 10 are combined with one another to form a desired size of the illumination device 1. That is, the illumination device 1 is modularized. Therefore, the cost of the manufacturing of the illumination device 1 is low.

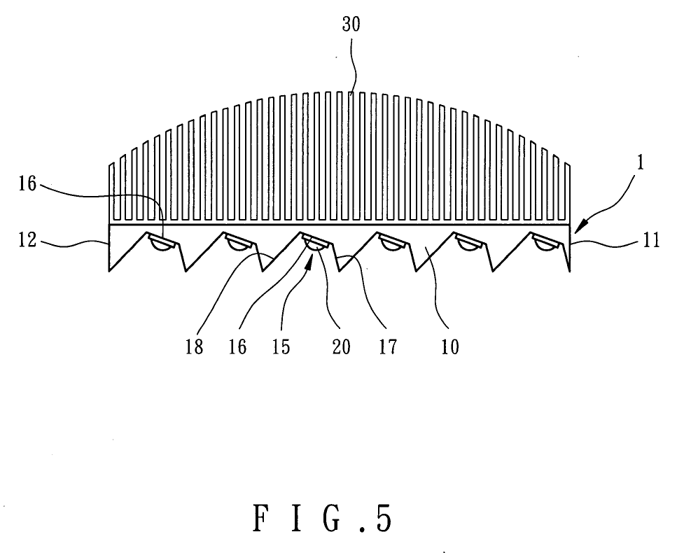

Referring to FIG. 5, a lamp holder according to a second embodiment of the present invention is shown. The second embodiment is like the first embodiment except including a radiator 30 formed with fins. Alternatively, a heat loop, radiating paste or cooling liquid may be used instead of the fins. With the radiator 30, heat can rapidly be dissipated from the lamp holder. Overheating of the LED 20 is avoided so that the LED 20 can be used for a long time.

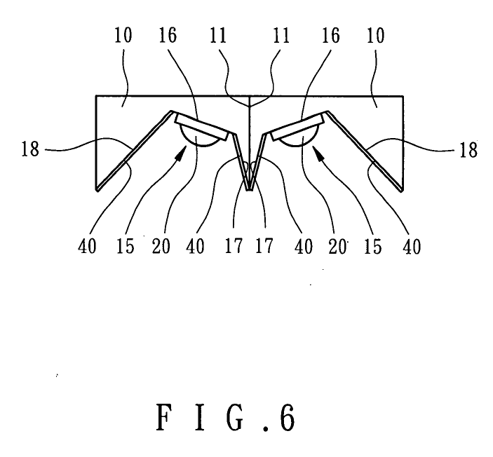

Referring to FIG. 6, a lamp holder according to a third embodiment of the present invention is shown. The third embodiment is like the first embodiment except including two reflectors 40. One of the reflectors 40 is attached to the reflective face 17 while the other reflector 40 is attached to the reflective face 18. The reflectors 40 are provided on the reflective faces 17 and 18 by coating or adhesion.

The lamp holder 10 exhibit several advantages. Firstly, the mounting face 16 directs the light emitted from the Led 20 downwards and outwards. The reflective faces 17 and 18 contain the light within a proper range so that the light illuminates a large area at a high luminance.

Secondly, the illumination device 1 can be made with a desired size because various sizes and numbers of lamp holders 10 can be assembled with one another.

Thirdly, the cost of the making of the illumination device 1 is low because various sizes and numbers of lamp holders are cut from at least one flat blank before they are assembled with one another.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A lamp holder being made by extrusion of aluminum and comprising at least one recess for receiving an illuminator, wherein the recess is defined by:
a mounting face at 18 to 25 degrees from a horizontal plane;
a first reflective face at 120 to 130 degrees from a lower edge of the mounting face; and
a second reflective face at 110 to 120 degrees from an upper edge of the mounting face.

2. The lamp holder according to claim 1, wherein the mounting face is at 20 degrees from a horizontal plane;

3. The lamp holder according to claim 1, wherein the first reflective face is at 124 degrees from the mounting face.

4. The lamp holder according to claim 1, wherein the second reflective face is at 114 degrees from the mounting face.

5. The lamp holder according to claim 1 comprising at least one radiator provided thereon.

6. The lamp holder according to claim 5, wherein the radiator is selected from a group consisting of fins, a heat loop, radiating paste and cooling liquid.

7. The lamp holder according to claim 1 comprising a reflector attached to each of the first and second reflective faces.

8. The lamp holder according to claim 7, wherein the reflectors are provided on the reflective faces in a manner selected from a group consisting of coating or adhesion.

9. An illumination device comprising at least two lamp holders according to claim 1, 2, 3, 4, 5 or 6 and at least two illuminators attached to the lamp holders.

10. The illumination device according to claim 9, wherein each of the lamp holders comprises a plurality of separate recesses.

11. The illumination device according to claim 9, wherein each of the lamp holders comprises a groove for receiving a plurality of illuminators.

12. The illumination device according to claim 9, wherein the lamp holder comprises an array of recesses.
